(19) United States
(12) Patent Application Publication
(10) Pub. No.: US 2005/0206971 A1
(43) Pub. Date: Sep. 22, 2005

(54) Multi-function object holder for supporting object to be scanned

(76) Inventor: Yu Cheng Chang, Taoyuan (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/801,372

(22) Filed: Mar. 16, 2004

(51) Int. Cl. H04N 1/04

(52) U.S. Cl. 358/498; 358/474

(57) ABSTRACT

A multi-function object holder is disposed on the scanning platform of a scanning apparatus for supporting different kinds of objects to be scanned by the scanning apparatus. The holder includes a base plate for supporting the scanned object and a cover plate for pressing and positioning the scanned object. The base plate has at least one scanning window where the scanned object is positioned, and a resting space for the accommodation of the cover plate when it is not in use. The cover plate is coupled to the base plate in all times but movable from the working position for pressing the scanned object to the resting position. After the cover plate is moved to the resting position, the scanning window can be provided for the scanning of an object that requires no pressing of the cover plate.

### FIELD OF THE INVENTION

The present invention relates to an object holder for supporting an object to be scanned, and more particularly to a multi-function object holder capable of supporting different kinds of objects to be scanned.

### BACKGROUND OF THE INVENTION

With the highly development of image processing techniques, not only opaque paper documents but also transparent originals such as films can be scanned into digital files. Various reflective, transmissive and reflective/transmissive dual-mode scanners have been developed for these purposes. When a transmissive scanning operation of a transparent object is performed, it is preferred that the scanned object is not in direct contact with the glass scanning platform in order to prevent from deteriorating the scanning quality, for example due to Newton's ring. In order to assure of suitable clearance between the transparent object and the scanning platform, a holder is used to support the transparent object for scanning.

Please refer to FIG. 1, in which a conventional film holder as disclosed in Taiwanese Patent Publication No. 456715 for used with a scanning apparatus is illustrated. The film holder 1 is used for supporting an elongated soft strip of film 2, e.g. the roll-type negative film commonly used with camera, and comprises a base plate 11 and a soft cover 12. Both of the base plate 11 and the soft cover 12 have openings 111 and 121 serving as a scanning window. When the film 2 is to be scanned, the soft cover 12 is upturned, to allow the film 2 to be placed onto the base plate 11, and then the soft cover 12 is put down to press the film 2 in position. The light emitted from a light source, which is generally disposed in the upper housing of the scanning apparatus (not shown), penetrates the opening 111, film 2 and opening 121 to be received and processed by the photoelectric converting device, which is generally disposed in the lower housing of the scanning apparatus. The soft cover 12 of this conventional film holder is made of rubber and has one end 122 secured onto an end portion 112 of the base plate 11. Therefore, the upturn and put-down operations of the soft cover 12 are performed by utilizing the flexible nature of the soft cover 12. After a number of upturn and put-down operations, the soft cover 12 is subject to breakage particularly at the fulcrum position 123. Further, since the soft cover 12 is secured onto the base plate 11 in a manner as shown, the soft cover 12 should always be put down to recover the stable configuration no matter when it is in use or not in use. In other words, the film holder of FIG. 1 is only suitable for supporting a thin and soft film but not suitable for supporting a framed film such as a slide.

Please refer to FIG. 2 which schematically shows another conventional film holder as disclosed in U.S. Pat. No. 6,169,611 B1. The film holder comprises a base plate 21 having a plurality of scanning windows 211 and a corresponding number of cover plate sets 22 pivotally secured to the base plate 21. For facilitating illustration, only one set of cover plates 221 and 222 are shown in the drawing. Initially, the cover plates 221 and 222 are resting above the corresponding scanning window 211. When an elongated soft strip of film (not shown) is to be scanned, the cover plates 221 and 222 are upturned about respective axes C-C, so that the film to be scanned can be placed on the scanning window 211. Afterwards, the cover plates 221 and 222 are pivoted about respective axes C-C again in an opposite direction to press the film. Since the upturned cover plates 221 and 222 will protrude from the base plate 211, the film holder of FIG. 2, just like the film holder of FIG. 1, is only suitable for supporting a thin and soft film rather than a framed film such as a slide that does not need any pressing cover.

Referring to FIG. 3, a further conventional film holder is illustrated. The film holder comprises a base plate 31 and a cover plate 32. The cover plate 32 is separable from the base plate 31. After an elongated soft strip of film (not shown) is placed on the scanning window 311 to be scanned, the cover plate 32 is attached to the base plate 31 with pieces 322 inserted into the slots 313 and pieces 321 clicked into slots 312 for pressing the film to be scanned. On the other hand, when a framed film which is relatively rigid and does not require the pressing of the cover plate 32 is to be scanned, the cover plate 32 has to be detached from the base plate 31, and the framed film is directly placed on the recess portion above the scanning window without being pressed by the cover plate 32. Meanwhile, the cover plate 32 not in use is separate from the base plate 31 and is possibly lost. Moreover, the assembling operation and storage of the cover plate 32 are troublesome.

### SUMMARY OF THE INVENTION

Therefore, the present invention provides a film holder suitable for supporting both elongated soft films and rigid framed films.

The present invention further provides a film holder easy to be operated and stored.

In accordance with a first aspect of the present invention, a multi-function object holder for optionally supporting a first object or a second object to be scanned, comprises a base plate for supporting the first or second object, having thereon a scanning window and a resting space; and a cover plate coupled to the base plate and movable between a working position over the scanning window for pressing the first object in position when the first object is to be scanned and a resting position inside the resting space when the second object is to be scanned.

Preferably, the scanning window and the resting space are arranged side by side and both extend along the scanning direction. More preferably, the scanning window and the resting space are identical to each other and symmetrically arranged.

In an embodiment, the resting space is a recess in the base plate.

Alternatively, the resting space is an opening in the base plate, and the base plate has a rack member inside the opening for supporting the cover plate when the cover plate is moved to the resting position.

Preferably, the rack member has a thickness less than a portion of the base plate around the opening, and a portion of the cover plate to be directly supported with the rack member has a thickness less than a portion of the cover plate resting in the opening so that the cover plate in each of the working and resting positions does not protrude from the base plate.

Preferably, the cover plate has a specific thickness so that an upper surface of the cover plate is aligned with an upper surface of the base plate in both the working position and the resting position.

In an embodiment, the cover plate is pivotally coupled to the base plate via a hinge device.

In another embodiment, the cover plate is coupled to the base plate via a slidably engaging device. The slidably engaging device, for example, includes a sliding member and a track member arranged on the base plate and the cover plate and engaging with each other, and the sliding member is slidable between the working position and resting position along the track member.

According to a second aspect, a multi-function object holder for optionally supporting a first object or a second object to be scanned, comprises a base plate for supporting the first or second object, having thereon a scanning window and a resting space; and a cover plate for pressing the first object on the scanning window when the first object is scanned, being hidden in the resting space without protruding from the base plate when the second object is to be scanned.

A third aspect of the present invention relates to a multi-function object holder for optionally supporting a first object or a second object to be scanned, which comprises a base plate for supporting the first or second object; and a movable plate moving to a first position when the first object is scanned and moving to a second position when the second object is scanned, wherein the movable plate in each of the first and second positions is coupled to the base plate.

Preferably, the movable plate is a cover plate for pressing the first object in position when moving to the first position and is an idle plate hidden inside the base plate when moving to the second position.

Preferably, the base plate includes a scanning window for placing thereon the first or second object to be scanned and a resting space immediately adjacent to the scanning window for hiding therein the cover plate when the second object is scanned.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing a first conventional film holder;

FIG. 2 is a schematic diagram showing a second conventional film holder;

FIG. 3 is a schematic diagram showing a third conventional film holder;

FIG. 4A is a resolving diagram schematically showing a first embodiment of a multi-function object holder according to the present invention;

FIG. 4B is a resolving diagram schematically showing a second embodiment of a multi-function object holder according to the present invention;

FIG. 5A is a top plane view of the film holder of FIG. 4A, which schematically shows the configuration of the multi-function object holder for supporting an elongated rigid film;

FIG. 5B is another top plane view of the film holder of FIG. 4A, which schematically shows the configuration of the multi-function object holder for supporting a rigid framed film;

FIGS. 6A-6E are side elevational views of the multi-function object holder of FIG. 4A, which schematically show the motion of the cover plate from a working position to a resting position;

FIG. 7 is a schematically top plane view of a third embodiment of a multi-function object holder according to the present invention;

FIGS. 8A-8C are cross-sectional views of the multi-function object holder taken along the A-A line of FIG. 7, which schematically show the motion of the cover plate from a working position to a resting position;

FIG. 9 is a resolving diagram schematically showing a fourth embodiment of a multi-function object holder according to the present invention; and

FIGS. 10A and 10B are top plane views of the multi-function object holder of FIG. 9, which schematically show the alternative working positions of the cover plate.

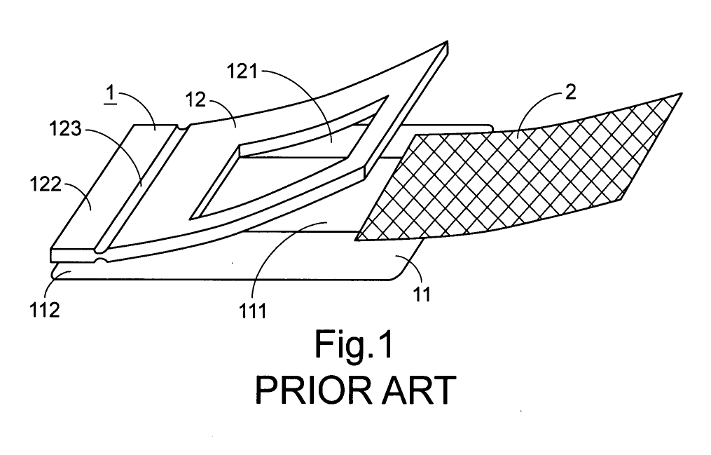

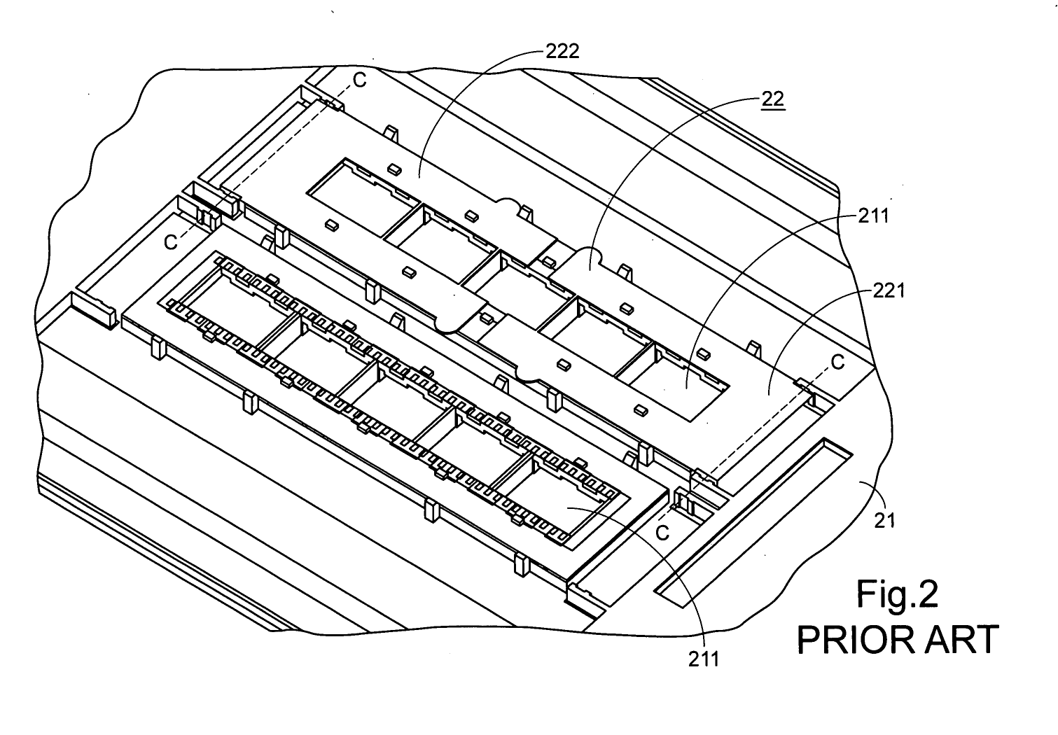

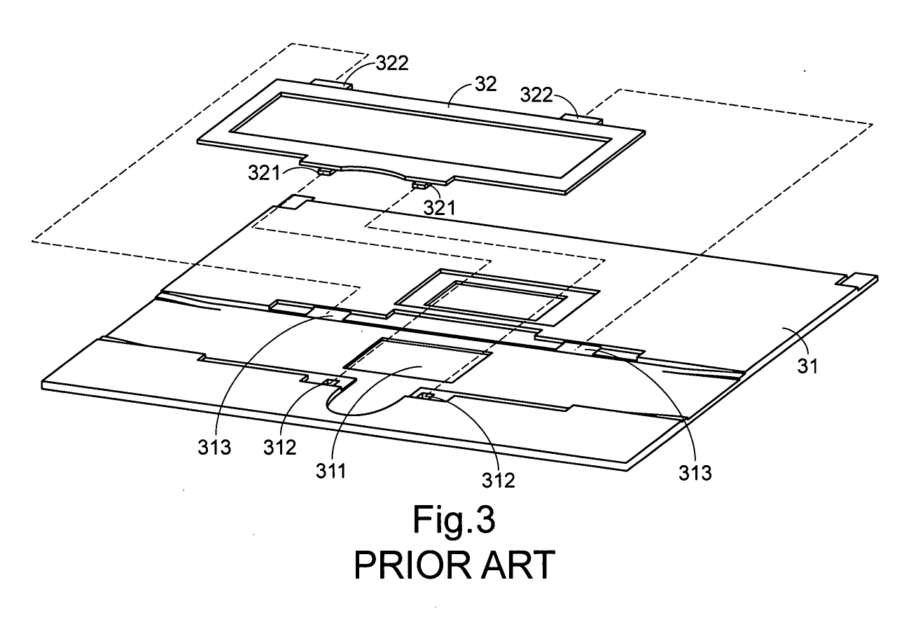

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

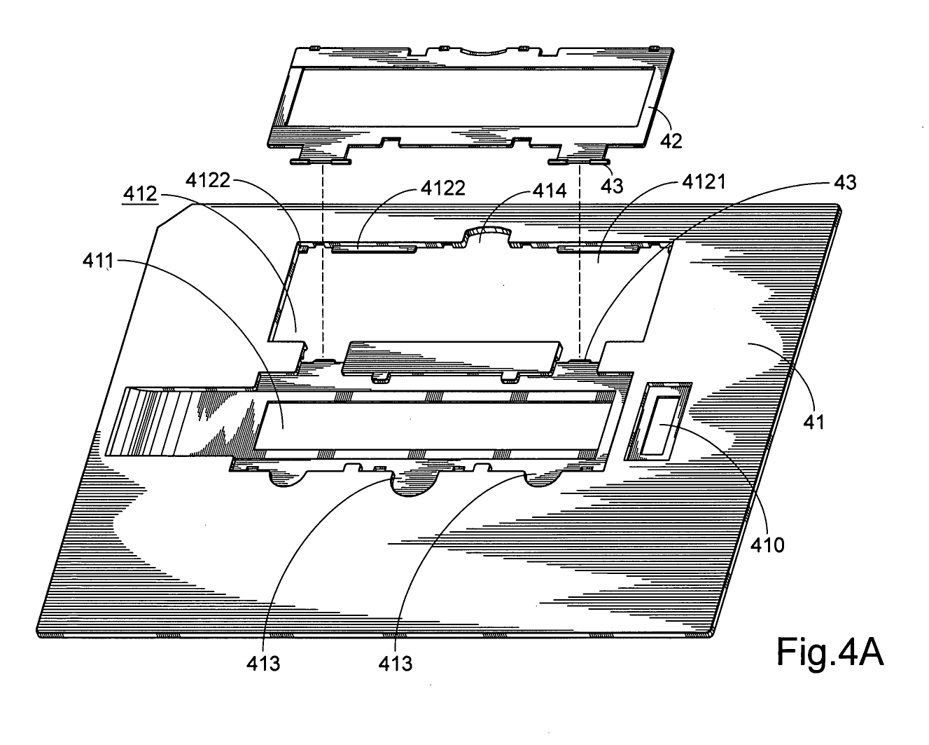

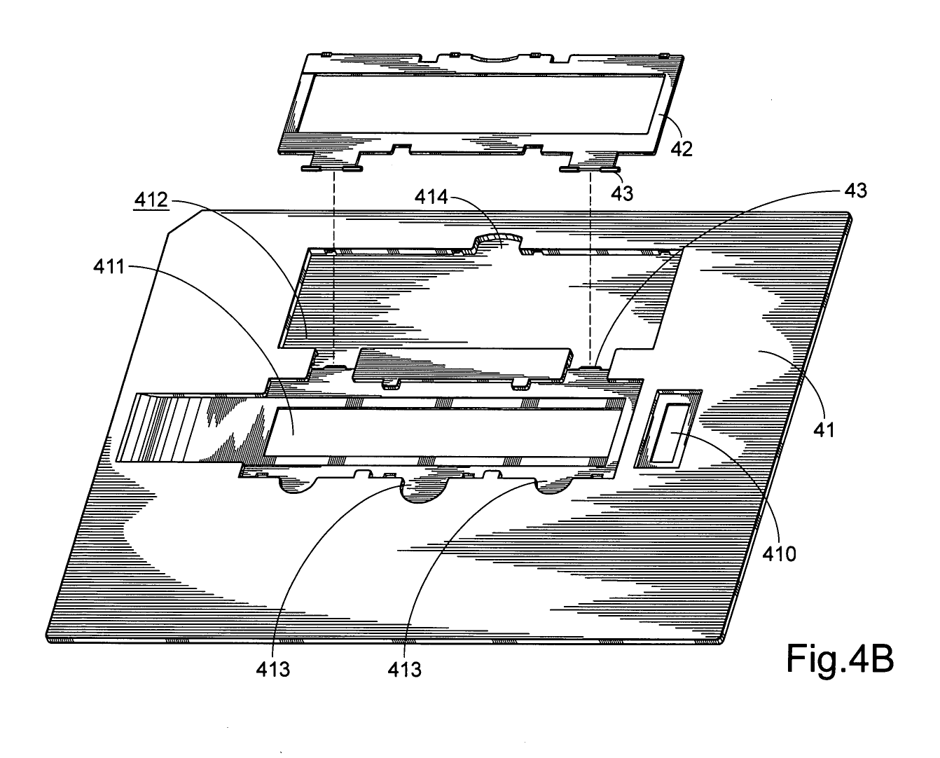

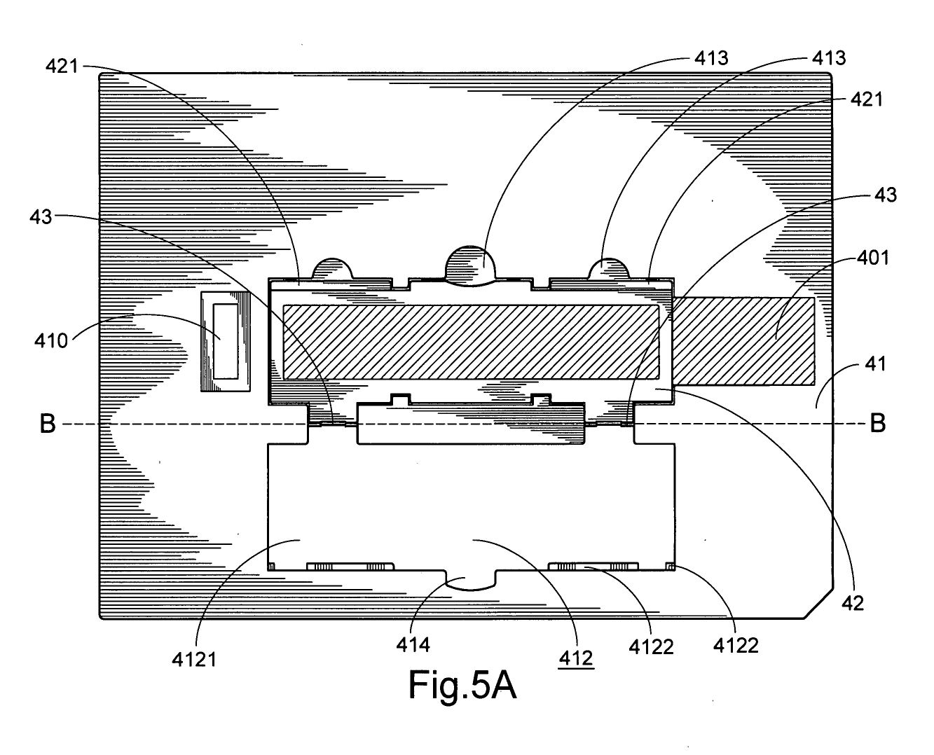

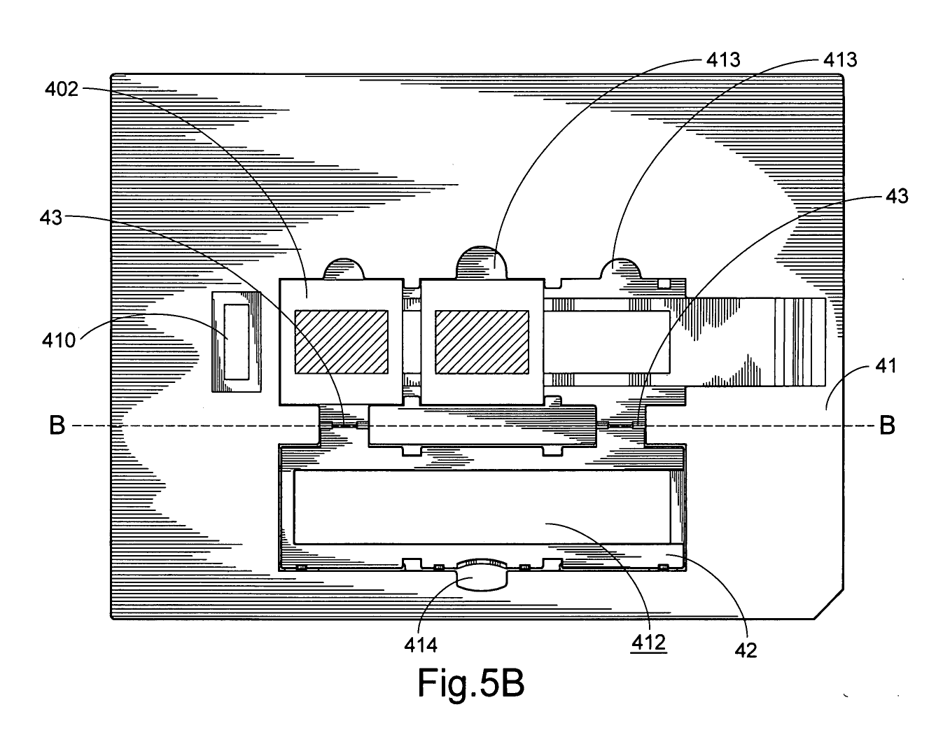

Please refer to FIGS. 4A and 4B. In each of the illustrated embodiments, the multi-function object holder includes a base plate 41 having a scanning window 411 and a resting space 412 and a cover plate 42. The scanning window 411 and cover plate 42 are adjacent to each other and both extend along the scanning direction that passes the calibration window 410 first and then the scanning window 411. While the resting space 412 as shown in FIG. 4B is a recess in the base plate 41, the resting space 412 as shown in FIG. 4A is an opening 4121 with racks 4122 for supporting the cover plate 42. The embodiment of FIG. 4B is applicable to a relatively thin holder. In each of the embodiments, the base plate 41 is thinned around the scanning window 411 for receiving the cover plate 42. Preferably, the thickness of the cover plate 42 is less than that of the base plate 41 so that the cover plate 42 does not protrude from the base plate 41 in both the working position and the resting position. More preferably, the upper surface of the cover plate 42 is exactly aligned with the upper surface of the base plate 41. For purpose of illustration, the multi-function object holders according to the present invention serve as film holders for supporting different kinds of films to be scanned. In order to be suitable for the scanning of both elongated soft films and rigid framed films, the cover plate 42 is movable between the scanning window 411 and the resting space 412. When an elongated soft strip of film 401 (see FIG. 5A), e.g. the roll-type negative film commonly used with camera, is to be scanned, the hollow cover plate 42 is moved toward the scanning window to press the negative film placed on the base plate 41 over the scanning window 411. On the other hand, when one or more framed films 402 (see FIG. 5B), e.g. slides, is to be scanned, the cover plate 42 should be moved toward the resting place because the framed films are relatively thick and rigid and do not require the pressing of the cover plate 42. For facilitating the removal of the framed film 402 or the pivotal operation of the cover plate 42 from the scanning window 411, at least one recess 413 having a size fitting a user's finger is preferably provided beside the scanning window 411. Further, in order to avoid the mislaying of the cover plate 42 when it is not in use, the cover plate 42 according to the present invention is attached to the base plate 41 while being movable between the working and the resting positions. In the embodiments shown in FIGS. 4A and 4B, the cover plate 42 is pivotally coupled to the base plate 41, for example via a hinge device 43. Further, it is preferred that, particularly in the embodiment of FIG. 4B where the resting space 412 is a recess, an opening 414 having a size fitting a user's finger is provided to facilitate the pivoting operation of the cover plate 42 from the resting space with the finger.

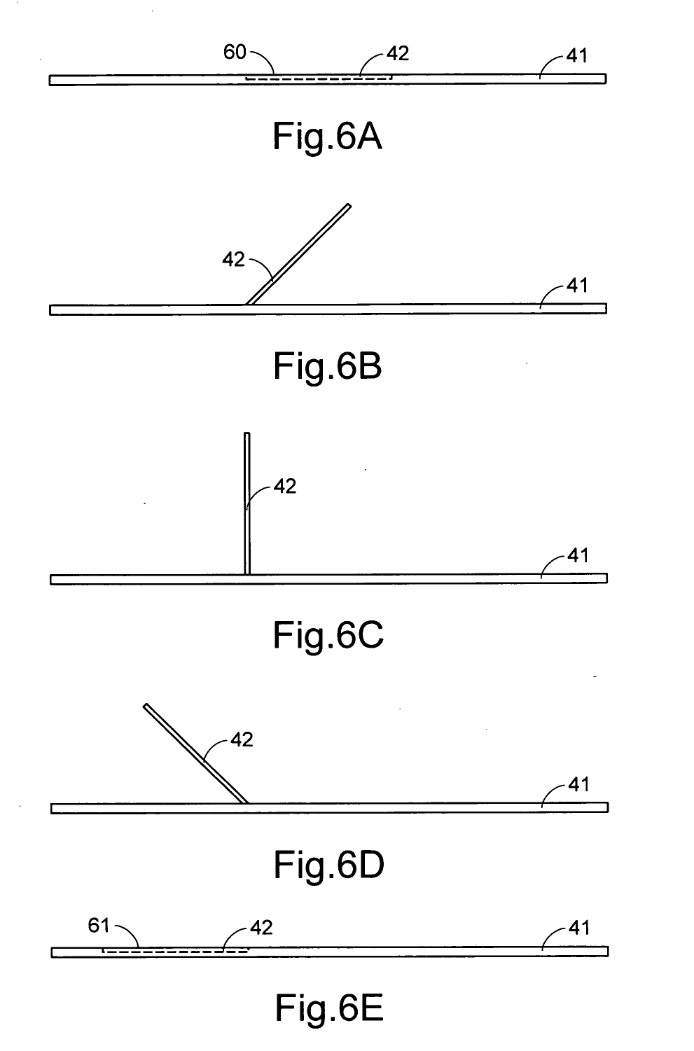

Please refer to FIGS. 5A and 5B, which are top plane views of the film holder of FIG. 4A schematically showing the configurations of the film holder for supporting elongated soft films and rigid framed films, respectively. In other words, the cover plate 42 is in working and resting positions as shown in FIGS. 5A and 5B, respectively. As described above, it is preferred that the cover plate 42 is exactly aligned with the upper surface of the base plate 41. Therefore, each of the racks 4122 has a thickness less than the other portion of the base plate 41 around the opening 4121, and a portion 421 of the cover plate 42 to be directly supported with the racks 4122 has a thickness less than the other portion of the cover plate 42. By this way, the cover plate 42 in each of the working and resting positions does not protrude from and is preferably aligned with the upper surface of the base plate 41. FIGS. 6A-6E, which are side elevational views of the film holder of FIG. 4A, further show the pivoting motion of the cover plate 42 about the B-B axis of FIG. 5A or 5B from the working position 60 to the resting position 61.

Although film holders for currently common uses are exemplified to illustrate the multi-function object holder according to the present invention in the above description, it is understood that the multi-function object holder according to the present invention can be used to support other objects to be scanned. The objects to be scanned can be transmissive or reflective originals. Different sizes, shapes or materials of objects, one of which requires the depressing of the cover plate while another one of which does not, can be supported by the present holder after slight modification in size and shape.

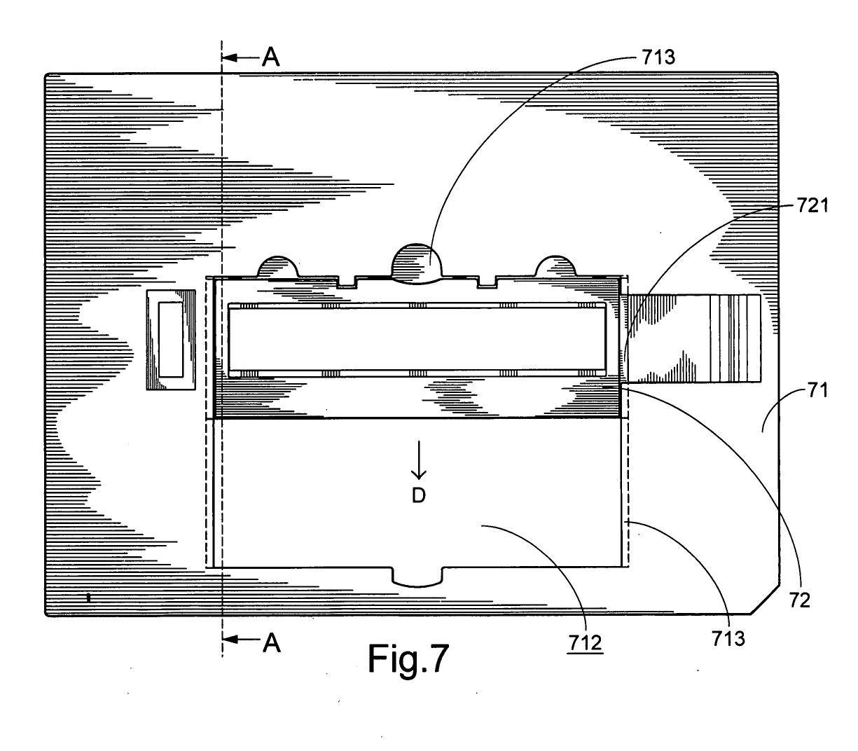

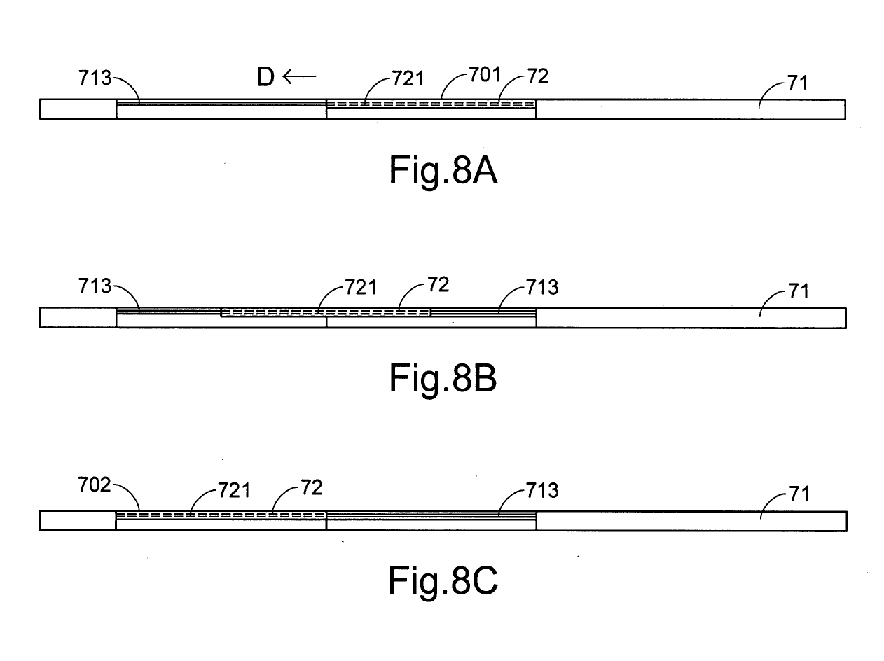

The embodiments of FIGS. 4-6 illustrate the movement of the cover plate between the working and resting positions by pivoting operations. Alternative, in another embodiment, the cover plate is moved between the working and resting positions by sliding operations. Please refer to FIG. 7, in which the cover plate 72 is slidable on the base plate 71 along a track 713 extending from the scanning window 711 to the resting position 712 with a slider member 721 (see FIG. 8). The track 713 should be properly arranged beside the scanning window 711 and resting space 712 so that a suitable clearance can be reserved between the scanning window 711 and the cover plate 72 for accommodating the object to be scanned. Cross-sectional views of the multi-function object holder taken along the A-A line of FIG. 7 are shown in FIGS. 8A-8C to show the motion of the cover plate 72 from the working position 701 to the resting position 702, as indicated by the arrow D. After the cover plate 72 moves to the resting position 702, a scanning operation of another object that does not require pressing of the cover plate 72 can be performed as described above.

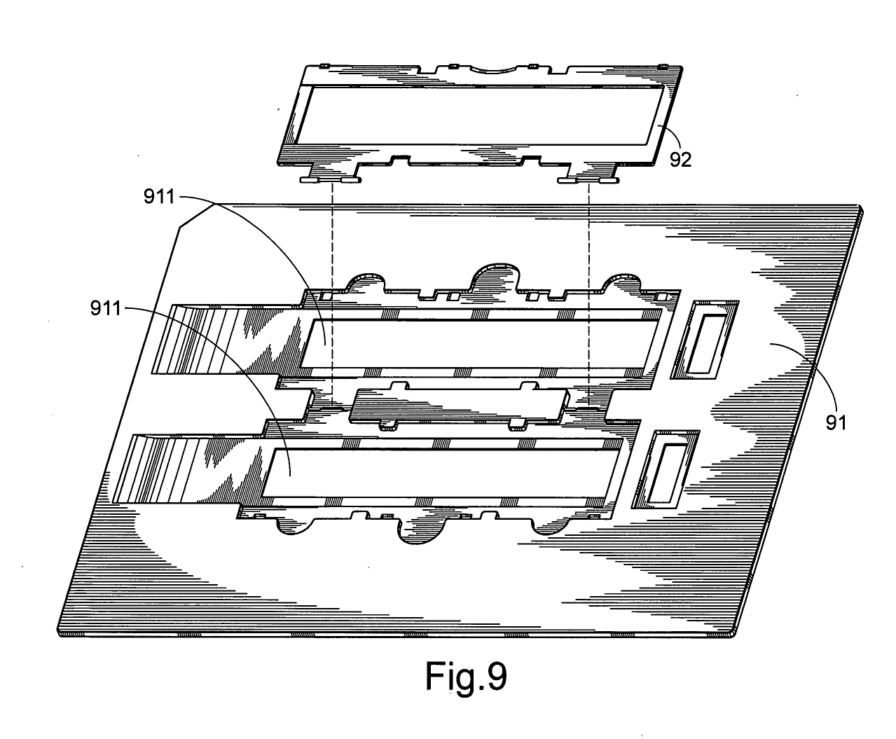

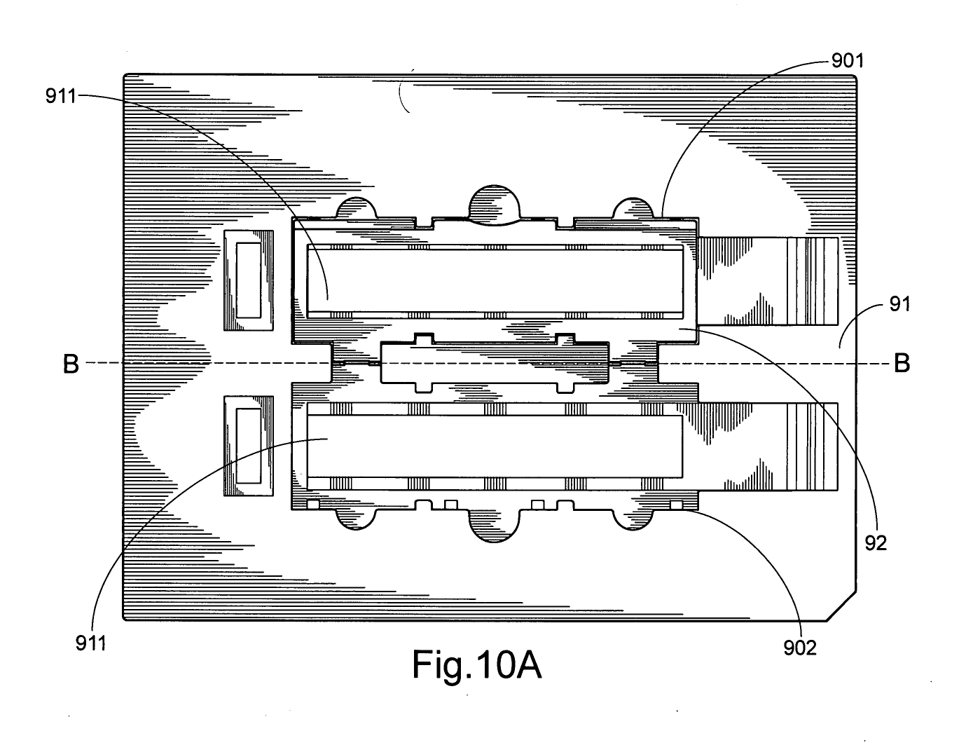

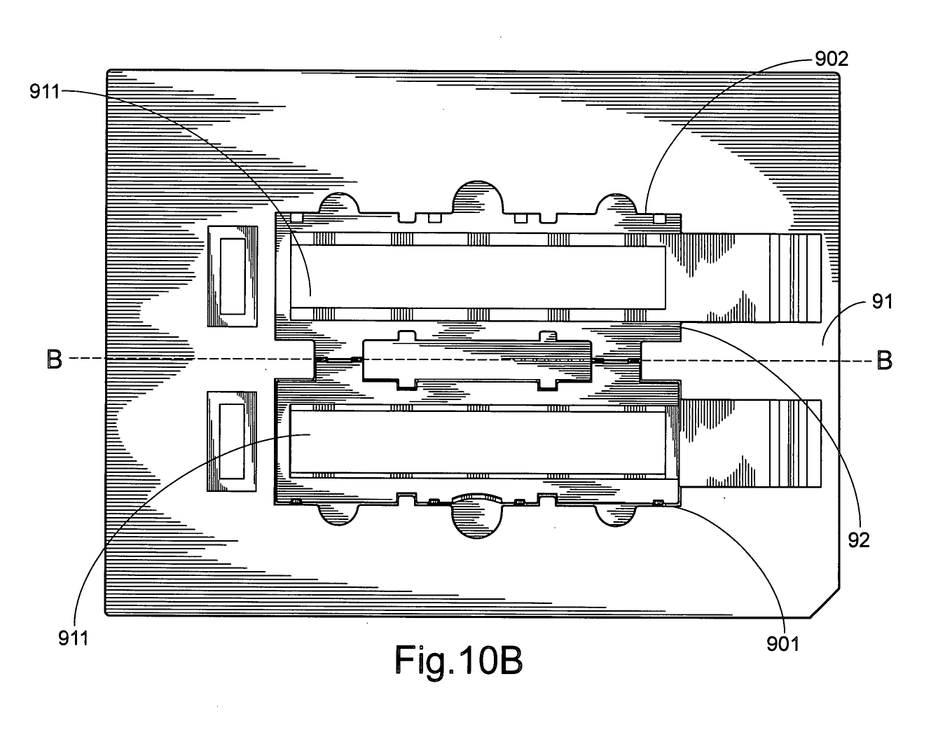

Since the multi-function object holder is placed on the scanning platform of a scanning apparatus only when the pressing of a scanned object is required. For example, the multi-function object holder is required when an elongated soft film is to be scanned. On the other hand, for a reflective/transmissive dual-mode scanner, the multi-function object holder should be removed when an object not fitting the holder, e.g. an A4-size document, is to be scanned. The frequent placing and removal of the holder onto/from the glass platform may increase the chance to result in damage, particular at the thin and weak parts such as the surrounding of the scanning window. Once the plate portion around the scanning window is broken or shattered, the object-positioning function of the holder could be adversely affected. Consequently, the holder has to be discarded. Therefore, according to a further embodiment of the present invention, a multi-function object holder similar to that of FIG. 4A but having exchangeable scanning window and resting space is provided for elongating the life span of the holder. Referring to FIG. 9, two identical and symmetrically arranged openings 911 are created in the base plate 91, each one of which can serve as the scanning window and each one of which can serve as the resting space. By this way, when there is any damage in one of the scanning portions, the other one can be used as a spare of the scanning window and the damaged one can be used as the resting space. FIGS. 10A and 10B schematically show the alternative working positions 901 and resting positions 902of the cover plate 92.

Likewise, more than two identical openings can be created in the base plate for providing replaceable scanning windows and multi-object scanning at the same time. For example, the presence of two cover plates allows two strips of elongated soft films to be pressed and scanned at the same time. Two strips of scanned films can be placed on the rightmost two scanning windows, leftmost two scanning windows or two side scanning windows, respectively. It is also inherent in this case that the position of a framed film supported by the holder is changeable.

It is understood from the above embodiments and descriptions that the present invention can achieve the purposes of scanning different kinds of objects with the same holder in an easily operating way. Furthermore, by duplication of the scanning window, the life span of the holder can be elongated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A multi-function object holder for optionally supporting a first object or a second object to be scanned, comprising:
a base plate for supporting said first or second object, having thereon a scanning window and a resting space; and
a cover plate coupled to said base plate and movable between a working position over said scanning window for pressing said first object in position when said first object is to be scanned and a resting position inside said resting space when said second object is to be scanned.

2. The multi-function object holder according to claim 1 wherein said scanning window and said resting space are arranged side by side and both extend along the scanning direction.

3. The multi-function object holder according to claim 2 wherein said scanning window and said resting space are identical to each other and symmetrically arranged.

4. The multi-function object holder according to claim 1 wherein said resting space is a recess in said base plate.

5. The multi-function object holder according to claim 1 wherein said resting space is an opening in said base plate.

6. The multi-function object holder according to claim 5 wherein said base plate has a rack member inside said opening for supporting said cover plate when said cover plate is moved to said resting position.

7. The multi-function object holder according to claim 6 wherein said rack member has a thickness less than a portion of said base plate around said opening, and a portion of said cover plate to be directly supported with said rack member has a thickness less than a portion of said cover plate resting in said opening so that said cover plate in each of said working and resting positions does not protrude from said base plate.

8. The multi-function object holder according to claim 1 wherein said cover plate has a specific thickness so that an upper surface of said cover plate is aligned with an upper surface of said base plate in both said working position and said resting position.

9. The multi-function object holder according to claim 1 wherein said cover plate is pivotally coupled to said base plate via a hinge device.

10. The multi-function object holder according to claim 1 wherein said cover plate is coupled to said base plate via a slidably engaging device.

11. The multi-function object holder according to claim 10 wherein said slidably engaging device includes a sliding member and a track member arranged on said base plate and said cover plate and engaging with each other, and said sliding member is slidable between said working position and resting position along said track member.

12. A multi-function object holder for optionally supporting a first object or a second object to be scanned, comprising:
a base plate for supporting said first or second object, having thereon a scanning window and a resting space; and
a cover plate for pressing said first object on said scanning window when said first object is scanned, being hidden in said resting space without protruding from said base plate when said second object is to be scanned.

13. The multi-function object holder according to claim 12 wherein said cover plate is pivotally coupled to said base plate via a hinge device.

14. The multi-function object holder according to claim 12 wherein said cover plate is coupled to said base plate via a slidably engaging device.

15. The multi-function object holder according to claim 12 wherein said scanning window and said resting space are identical to each other and symmetrically arranged.

16. A multi-function object holder for optionally supporting a first object or a second object to be scanned, comprising:
a base plate for supporting said first or second object; and
a movable plate moving to a first position when said first object is scanned and moving to a second position when said second object is scanned, wherein said movable plate in each of said first and second positions is coupled to said base plate.

17. The multi-function object holder according to claim 16 wherein said movable plate is pivotally coupled to said base plate via a hinge device.

18. The multi-function object holder according to claim 16 wherein said movable plate is coupled to said base plate via a slidably engaging device.

19. The multi-function object holder according to claim 16 wherein said movable plate is a cover plate for pressing said first object in position when moving to said first position and is an idle plate hidden inside said base plate when moving to said second position.

20. The multi-function object holder according to claim 19 wherein said base plate includes a scanning window for placing thereon said first or second object to be scanned and a resting space immediately adjacent to said scanning window for hiding therein said cover plate when said second object is scanned.
